(19) United States
(12) Patent Application Publication
(10) Pub. No.: US 2010/0293234 A1
(43) Pub. Date: Nov. 18, 2010

(54) SYSTEM AND METHOD FOR INCORPORATING USER INPUT INTO FILTER-BASED NAVIGATION OF AN ELECTRONIC CATALOG

(75) Inventor: Daniel F. SCHMIDT, San Francisco, CA (US)

Correspondence Address: NIXON PEABODY, LLP, 401 9TH STREET, NW, SUITE 900, WASHINGTON, DC, 20004-2128, US

(73) Assignee: CBS INTERACTIVE, INC., County of New Castle, DE (US)

(21) Appl. No.: 12/467,414

(22) Filed: May 18, 2009

(51) Int. Cl. G06F 17/30; G06F 3/048; G06F 15/16

(52) U.S. Cl. 709/206; 715/764; 707/E17.017

(57) ABSTRACT

Various embodiments are presented which comprise an electronic catalog of products, wherein the catalog comprises a taxonomy of product categories and products within the categories, wherein various users input filter parameters to construct user constructed filters. These user constructed filters allow custom, dynamically updated access to the catalog and are shared by users in a community.

### CROSS-REFERENCE TO RELATED APPLICATIONS

The present invention shares common subject matter with the following applications, which also share common inventor and assignee: “SYSTEM AND METHOD FOR TARGETING CONTENT BASED ON FILTER ACTIVITY”, “SYSTEM AND METHOD FOR PRESENTING FILTER OPTIONS TO A USER BASED ON ONGOING MONITORING OF FILTER SELECTIONS”, and “SYSTEM AND METHOD FOR TRACKING FILTER ACTIVITY AND MONITORING TRENDS ASSOCIATED WITH SAID ACTIVITY”, all also submitted on this date. These co-pending applications were not previously published in any form.

### FIELD OF THE INVENTION

The present invention relates to a system and method for providing a community of users with a means of sharing user constructed filters to navigate an online catalog of products.

### DESCRIPTION OF THE RELATED ART

Many websites are configured as online catalogs. These catalogs act as alternatives to traditional paper catalogs and offer enhanced navigational features when compared to their paper counterparts, as well as the advantages of broad, easy distribution. With the advent and increasing popularity of the Internet, suppliers have access to a much larger customer base. Through the Internet, the market base of manufacturers and resellers may be maximized while the associated overhead may potentially be drastically reduced. If an electronic catalog is well-organized and presented, it can help consumers to make good purchasing decisions by providing extensive information about the products they contain in an easy-to-navigate manner. Such a catalog either allows the consumers to gain information about products they will purchase elsewhere or to make purchases within the site itself. Additionally, such a catalog serves as a site where companies may purchase advertising to market their products.

Such electronic catalogs generally store, in a database, information about a number of products which may be anything from electronics to housewares to apparel, or any other type of item which may be depicted and/or described electronically. Such items may be described by a taxonomy, which describes the set of products with a set of information that consists of a set of attributes that assume values. That is, each product might be associated with a price, brand, or other attribute. Some attributes would only be stored for some classes of product. For example, weight might be a attribute with respect to laptops, but not desktop computers, while both might have a processor speed attribute.

Once a retailer or other content provider has provided a taxonomy for its products, it remains for the users of the catalog system to retrieve the products using the taxonomy system. One way to do this is by performing searches using filters. These filters are composed of individual filter parameters, which are rules which narrow the selection of products in a taxonomy according to some criterion. Such filters constrain the allowable values of the attributes, and thereby generate a more manageable subset of the products that the user may use, manipulate, and digest. Together, a set of filter parameters forms a filter, which represents a progressively narrowed selection of filter parameters. An example filter would be that if a user were searching for digital cameras, the user might want cameras from Canon™, which are 6 megapixels or greater, and which are under $300 in price. A filter further consists of the individual, discrete filter parameters, which limit the user's search in a progressive manner. Each filter parameter imposes a constraint on one or more product attributes at a time, within a given category.

Filters allow the users to reduce the potentially huge numbers of products which otherwise occupy catalogs and reduce them to a manageable numbers. They also allow users to focus their searches to meet their individualized needs, as well as incorporating factors such as ability to pay or brand requirements due to purchasing contracts.

It is known in the art to allow users to generate their own custom lists, such as Amazon's Listmania™ in which users of a catalog create lists within a catalog by selecting specific items in a list that they wish to share with the community of users. However, this approach has the disadvantage that the lists are static and do not change as the catalog does. For example, a list that was designed to be a list of “Excellent Organic Chemistry textbooks” would not reflect the presence of a new organic chemistry textbook in the catalog published after the list was made, even though the author of the list might consider it to fall within the list criteria.

### SUMMARY OF THE INVENTION

These embodiments of the invention propose a solution to the problem that lists which are composed of a static, predetermined set of products do not reflect changing conditions within a catalog when reflecting customized subsets of the catalog's product which reflect special interests or individual preferences. Instead, the embodiments suggest the approach that by utilizing filters, which consist of one or more filter parameters, each of which specifies at least one of a product category and an attribute, various embodiments may be implemented which automatically narrow the products in the catalog to produce a customized list which is dynamic because the filter parameters may be applied to select the products in the catalog which correspond with the constraints they represent to yield a subset of the catalog that reflects preferences but adapts to changes in the composition of the catalog by reapplying the filters as the combination of products in the catalog changes.

Moreover, the embodiments represent a solution where the filters are stored for communal use, so that individual users can create filters for the benefit of other users. By managing access to filters that users create on a communal basis, the benefit of the filters is enhanced greatly, because other users can have collaborative access to the filters. This allows users to create filters which have special meaning for groups of friends, co-workers and family, or to potentially create filters for customers to expedite customers' use of the catalog. Some embodiments additionally offer messaging capabilities where an e-mail, TXT message, or instant message (IM) is used to inform the user about the existence of a user constructed filter. More importantly, the dynamic nature of the lists can be leveraged by using messaging technologies to alert a user of the various embodiments when the results of applying the user constructed filter to the catalog have changed.

According to one embodiment of the invention, there is provided: A computer system, comprising: a computer processor, a database module that stores an electronic catalog of products, wherein the catalog comprises a taxonomy of products categories and products within the categories, the catalog further comprising attributes which describe products in a category and at least one value for said attributes, a user interface module configured to allow one or more users to define one or more user constructed filters, wherein each user constructed filter includes a set of filter parameters, each of which specifies at least one of a product category and an attribute, which when applied to the catalog generates a subset of products in the catalog which correspond with the filter parameters, and a community user constructed filter repository module, which stores said user constructed filters and allows subsequent access to the catalog via the user constructed filters by said one or more users by applying the user constructed filter to a subset of products in the catalog which correspond with the filter parameters given the current state of the catalog at the time of the access.

According to one embodiment of the invention, there is provided: A method involving steps to be performed on a computing system consisting of multiple modules designed to perform computing functions which transform data monitoring results, wherein at least part of the computing system's functionality is performed by hardware, comprising: controlling the operation of the modules using a computer processor, storing an electronic catalog of products with a database module, wherein the catalog comprises a taxonomy of products categories and products within the categories, the catalog further comprising attributes which describe products in a category and at least one value for said attributes, defining with a user interface module configured to allow one or more users to define one or more user constructed filters, wherein each user constructed filter includes a set of filter parameters, each of which specifies at least one of a product category and an attribute, which when applied to the catalog generates a subset of products in the catalog which correspond with the filter parameters, and storing a community user constructed filter repository module, which stores said user constructed filters and allows subsequent access to the catalog via the user constructed filters by said one or more users by applying the user constructed filter to a subset of products in the catalog which correspond with the filter parameters given the current state of the catalog at the time of the access.

According to one embodiment of the invention, there is provided: An apparatus designed to perform computing functions which transform data monitoring results, wherein at least part of the apparatus's functionality is performed by hardware, comprising: means for controlling the operation of the modules using a computer processor, means for storing an electronic catalog of products with a database module, wherein the catalog comprises a taxonomy of products categories and products within the categories, the catalog further comprising attributes which describe products in a category and at least one value for said attributes, means for defining with a user interface module configured to allow one or more users to define one or more user constructed filters, wherein each user constructed filter includes a set of filter parameters, each of which specifies at least one of a product category and an attribute, which when applied to the catalog generates a subset of products in the catalog which correspond with the filter parameters, and means for storing a community user constructed filter repository module, which stores said user constructed filters and allows subsequent access to the catalog via the user constructed filters by said one or more users by applying the user constructed filter to a subset of products in the catalog which correspond with the filter parameters given the current state of the catalog at the time of the access.

According to one embodiment of the invention, there is provided: Computer readable media, having instructions stored thereon, wherein the instructions, when executed by a processor, perform computing functions which transform data monitoring results, comprising: instructions for controlling the operation of the modules using a computer processor, instructions for storing an electronic catalog of products with a database module, wherein the catalog comprises a taxonomy of products categories and products within the categories, the catalog further comprising attributes which describe products in a category and at least one value for said attributes, instructions for defining with a user interface module configured to allow one or more users to define one or more user constructed filters, wherein each user constructed filter includes a set of filter parameters, each of which specifies at least one of a product category and an attribute, which when applied to the catalog generates a subset of products in the catalog which correspond with the filter parameters, and instructions for storing a community user constructed filter repository module, which stores said user constructed filters and allows subsequent access to the catalog via the user constructed filters by said one or more users by applying the user constructed filter to a subset of products in the catalog which correspond with the filter parameters given the current state of the catalog at the time of the access.

### BRIEF DESCRIPTION OF THE DRAWINGS

FIG. 1 is a diagram illustrating the interactions between the components of a system embodiment of the present invention.

FIG. 2 is a diagram illustrating a taxonomy in accordance with system in which the present invention may be implemented.

FIG. 3 is a screenshot of an catalog in accordance with the invention depicting a front-page for category selection.

FIG. 4 is a screenshot of an catalog in accordance with the invention depicting a page where the cell phone category has been selected.

FIG. 5 is a screenshot of an catalog in accordance with the invention depicting a page where AT&T™ cell phones have been selected.

FIG. 6 is a screenshot of an catalog in accordance with the invention depicting a AT&T™ cell phones selling for between $50-$100 have been selected.

FIG. 7 is a screenshot of an catalog in accordance depicting a AT&T™ cell phones selling for between $50-$100 made by Sony Ericsson™ have been selected.

FIG. 8 is a flowchart illustrating the method according to one embodiment of the invention.

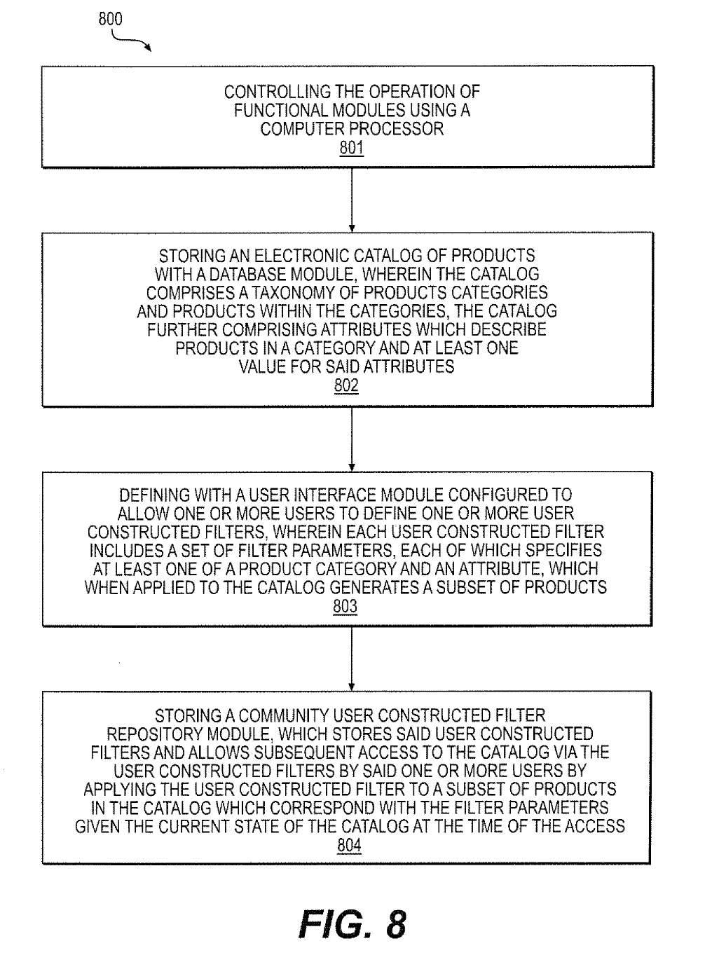

FIG. 9 is a mock display of a catalog interface which offers to user constructed filters for laptops.

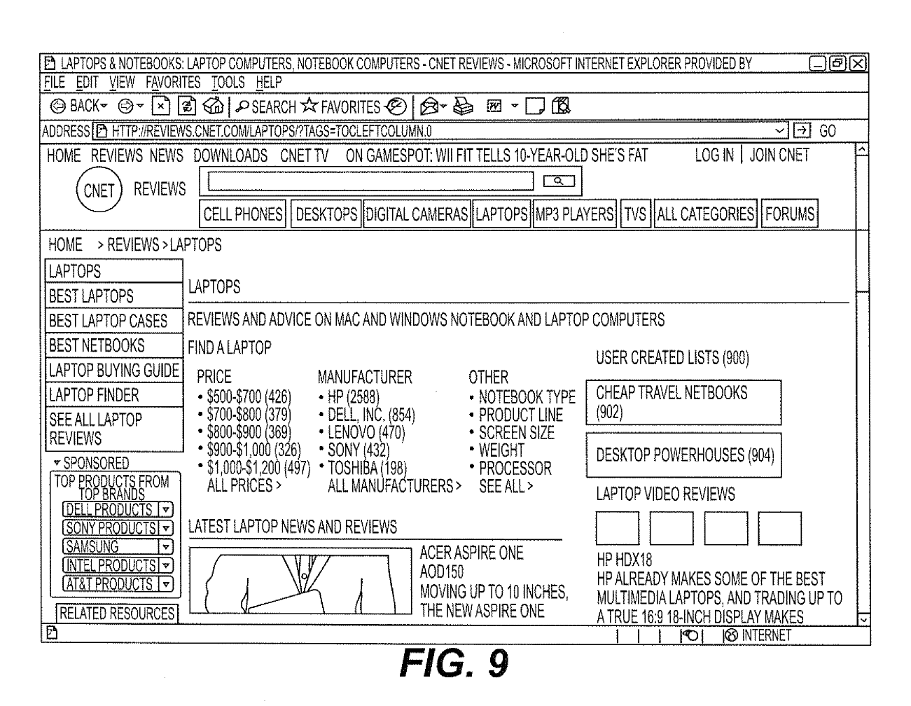

FIG. 10 is a mock display of running the “Cheap travel netbooks” filter in the context of the catalog.

FIG. 11 is a mock display of running the “Desktop powerhouses” filter in the context of the catalog.

FIG. 12 is a display of information stored in the Community User Constructed Filter Repository Module.

FIG. 13 is a mock display of a mechanism for entering a new user constructed filter.

### DETAILED DESCRIPTION OF THE INVENTION

In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

Embodiments are described herein that involve catalog data to which is stored and organized in an efficient manner through the use of a taxonomy. The taxonomy categorizes the products by using attributes, where products are associated with one or more values of the attributes. Such attributes describe and organize the products in the catalog for retrieval.

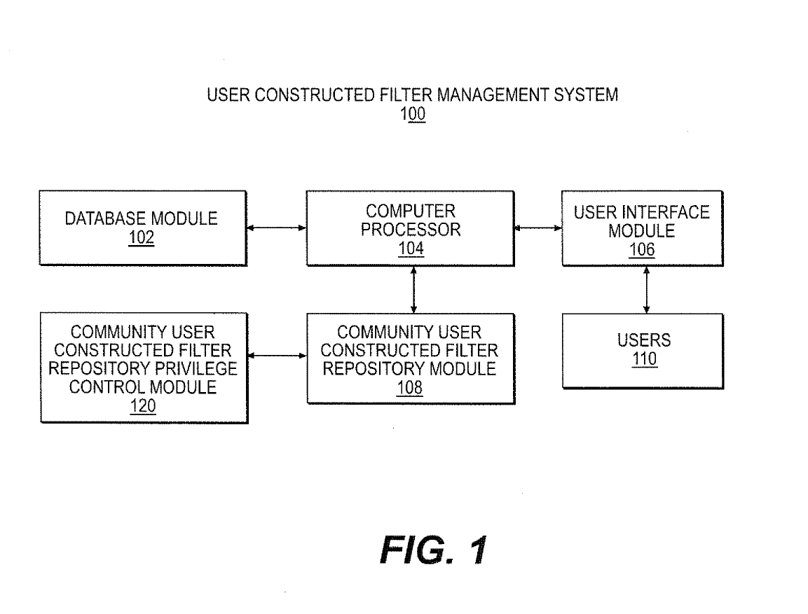

The configuration of the user constructed filter management system 100 is characterized in FIG. 1. The catalog is ideally stored in a database module 102. The database may preferably employ a relational model, though it may alternatively employ a flat model, hierarchical model, network model, dimensional model, object model, object-relational model or any combination of the above or other database formats. The database may use a querying language such as SQL to retrieve data internally. Alternatively, the catalog may be stored in another file or collection of files such as a word processing document, or spreadsheet. The catalog information may be stored on a single machine or on multiple machines over a network. Ideally the catalog is accessible over the Web though a web browser or over another network, but embodiments exist where the catalog is accessible directly from a dedicated program where the catalog is stored locally. The contents of the catalog may be stored upon any tangible medium, such as, but not limited to: magnetic media, optical media, magneto-optical media, solid-state memory, and/or flash memory. The catalog may be stored locally or distributed over a network.

The database receives requests to access the contents of the catalog under the control of the computer processor 104, which mediates requests which are required by the user interface module 106, which may preferably be a monitor with input devices such as a keyboard and mouse providing a Web page, or other GUI interface, but may also involve alterative forms of interaction such as a command line, audio input/output or printed output, or assorted I/O peripherals such as a joystick, gamepad, trackpad, trackball, or other forms of I/O such as those used by the disabled, in order to interact with the users 110 and inform them about the operation of the system and obtain their desired filter parameters. This information flows to and from the user interface module 106 to the community user constructed filter repository module 108, where the access to the user constructed filters is managed. The community user constructed filter repository module 108 then presents the results of its computation to the users 110 via the user interface module 106.

Within the catalog, the taxonomy allows the products to be divided into categories, each of which has subcategories with their own particular set of subcategories. This categorization exists based on the structure of the attributes that are each associated with a given category of product. As an example, in one embodiment, the products could be computers, which are divided into subcategories of laptops and desktops. The laptops can be further subdivided into subcategories, which might include “netbook”, “thin-and-light”, “mainstream”, and “desktop replacement”. Attributes in these subcategories can be weight, price (which might be divided by ranges), and type of processor. On the other hand the desktops might also be have the attributes of price and type of processor, but might have other attributes associated with them, like “form factor” and “number of drive bays”. Moreover, certain attributes might have multi-leveled answers. For example, a processor might be have a processor brand of Intel™, which would then lead to an attribute to differentiate that it was a “Core 2™”, then “Core 2 DUO™” as opposed to “Core 2 Quad™”. Some attributes which are of particular use if the catalog refers to technological products would attributes which specify the brand, price, and various aspects of the technology involved in the product, such as particular technological features, such as speed, capacity, or special capabilities inherent to a device.

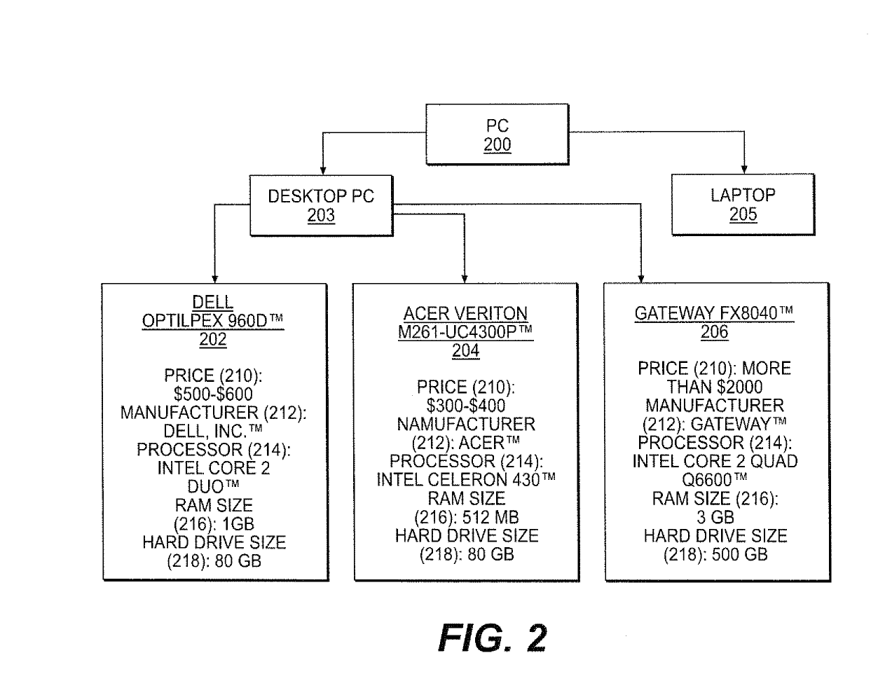

An example taxonomy is presented in FIG. 2, for Desktop PCs. The category of PCs 200 branches into the subcategories of Desktop PCs 203 and Laptop PCs 205. Desktop PCs 203 contain 3 examples of Desktop PCs, Dell Optiplex 960D™ (202) Acer Veriton M261-UC4300P™ (204), and the Gateway FX8040™ (206). Each of these has a value for attributes such as price 210, manufacturer 212, processor 214, RAM size 216, and hard drive size 218. Clearly, the implementation of such a taxonomy will differ by the database model or alternative schema used to store the database in the database module 102. However, given a relational model, such a taxonomy can be stored in one embodiment by associating the products with unique product IDs, then creating tables that associate the IDs with attributes, then creating tables that associate the IDs within the attributes with various values within the taxonomy, in a manner well known in the art to associate pieces of data with information that describes them through relational tables. However, many alternative embodiments are possible and this merely represents a preferred method of storing the catalog if the RDBMS approach is chosen.

it is to be noted that the catalog need not represent a set of tangible products represented by nodes within the taxonomy. The catalog may also operate on a digital level, and contain items of digital content. These items may contain digital text, audio, MIDI data, recorded audiobooks, digital music, bitmapped and/or vector graphics, digital photographs, video, movies, TV episodes, digital documents, animations, software, web content, multimedia, any form of encoded or archived data, and/or any other type of file or group of files which may be use to store useful computer data. These files may be stored locally or remotely from the web site or other interface shell which is used to allow the user to access the catalog.

Ideally, a catalog which is an embodiment of the invention which incorporates one or more of these data types will operate as described below, except that attributes of the one or more data types will reflect characteristics of the type of data involved when using filters instead of characteristics of merchandise. For example, a catalog which contains video might have attributes such as “length” (which might be various ranges of minutes), “type” (which might be “black-and-white” or “color”, or alternatively might include different levels of color quality), or might involve more qualitative attributes such as “genre” (i.e. action, comedy, drama, science-fiction, western) or “rating” (i.e., some sort of scale such as a star system or a points system). Note that some catalogs will have items in the taxonomy which may reflect pieces of merchandise which are linked to “virtual merchandise”, that is pieces of digital media . . . for example, pieces of digital music might be linked to real-world CD albums on which the songs are located. Within the context of these attributes, the embodiments may facilitate the management and access to the media by controlling which filters are available at a given point in time.

Building upon the catalog, the embodiments allow the products to be accessed through the use of filters. These filters consist of combinations of filter parameters which limit the values of products in the catalog which will ultimately be selected. These filter parameters each specify at least one of a product category and an attribute. For example, given that a user was trying to find products in the laptops and desktops categories, both of those categories could be filter parameters for a filter, and additionally the filter might specify additional attributes of the computer that the user was searching for, such as that the computer should have at least 2 GB of RAM, 100 GB of hard drive space, an Intel™ processor, and that the processor should be a Core 2 Duo™.

The order in which filter parameters are selected may be significant during the selection process, because, for example, if the user selects cameras such that they are 10 MP or greater as his or her first constraint, this may lead to available lens types that would not have been available had, for example, the user selected a camera that is $50 or less. However, assuming that a set of parameters is compatible with each other, an overall set of filters is not order-dependent once they have been selected.

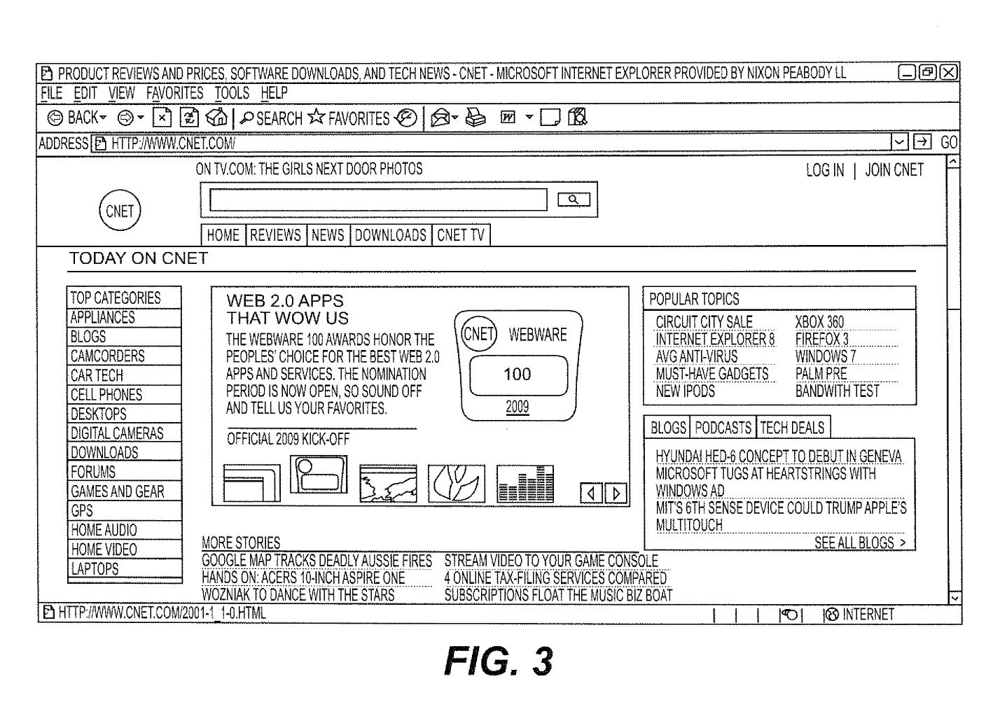

Screenshots illustrating an example of a catalog interface which would contain an assortment of technology products and then progressively use filter parameters to narrow the selection of products which are under consideration are displayed in FIG. 3-7. Furthermore, the embodiments record and monitor one or more users' choice of filters over time, providing a pool of data which can then been used as a basis, in combination with a new filter selection, for recommendations of content.

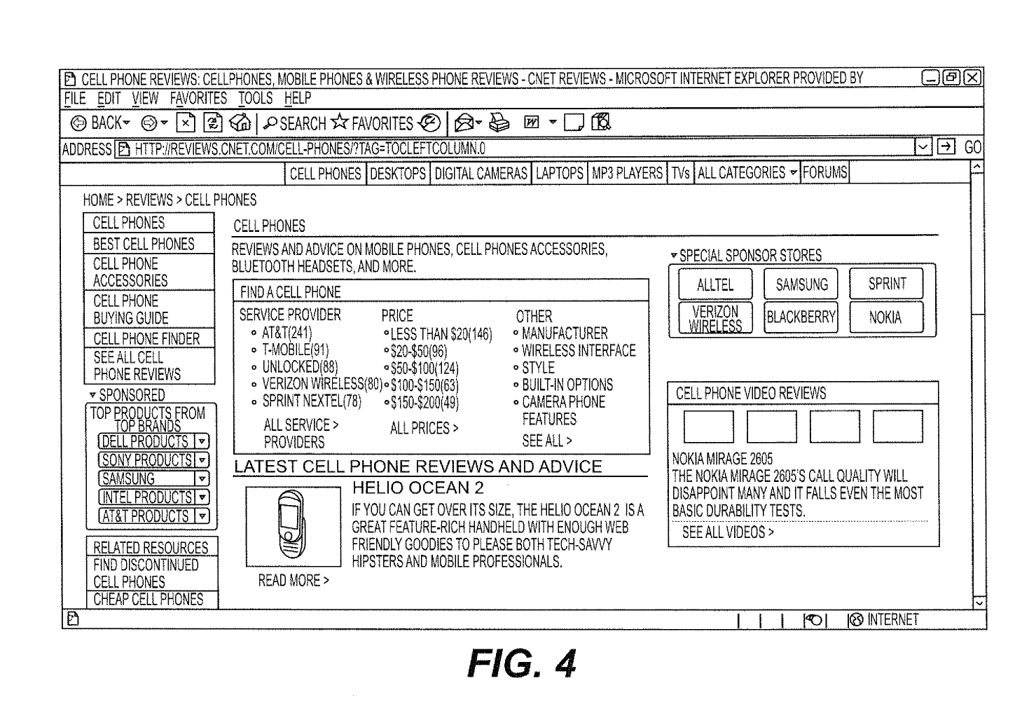

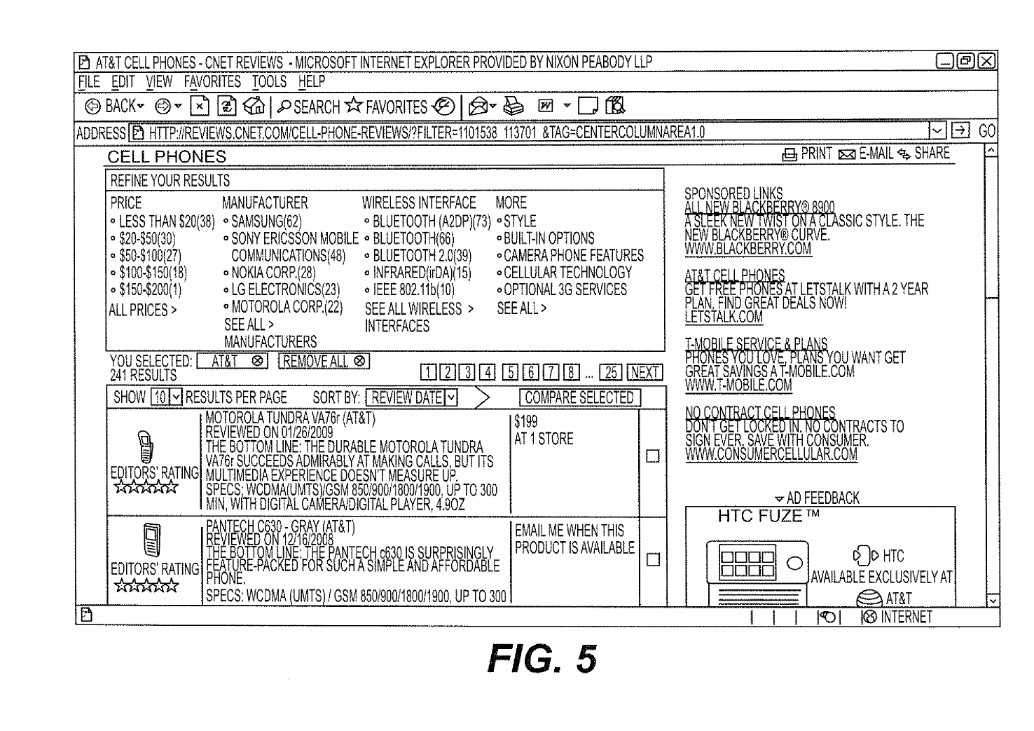

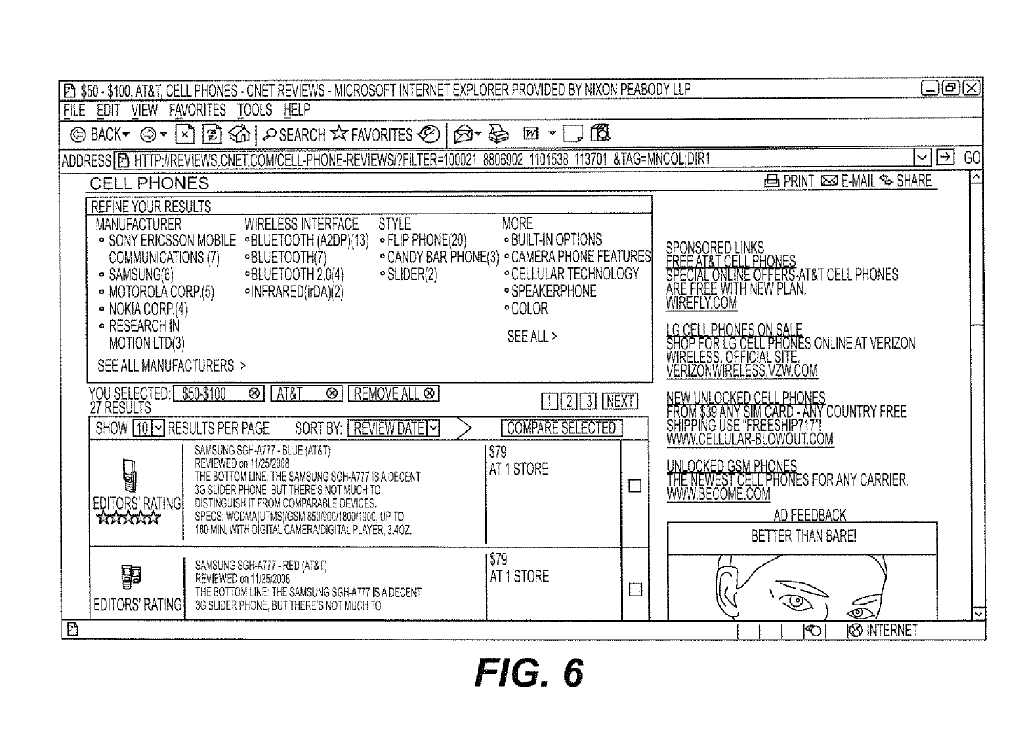

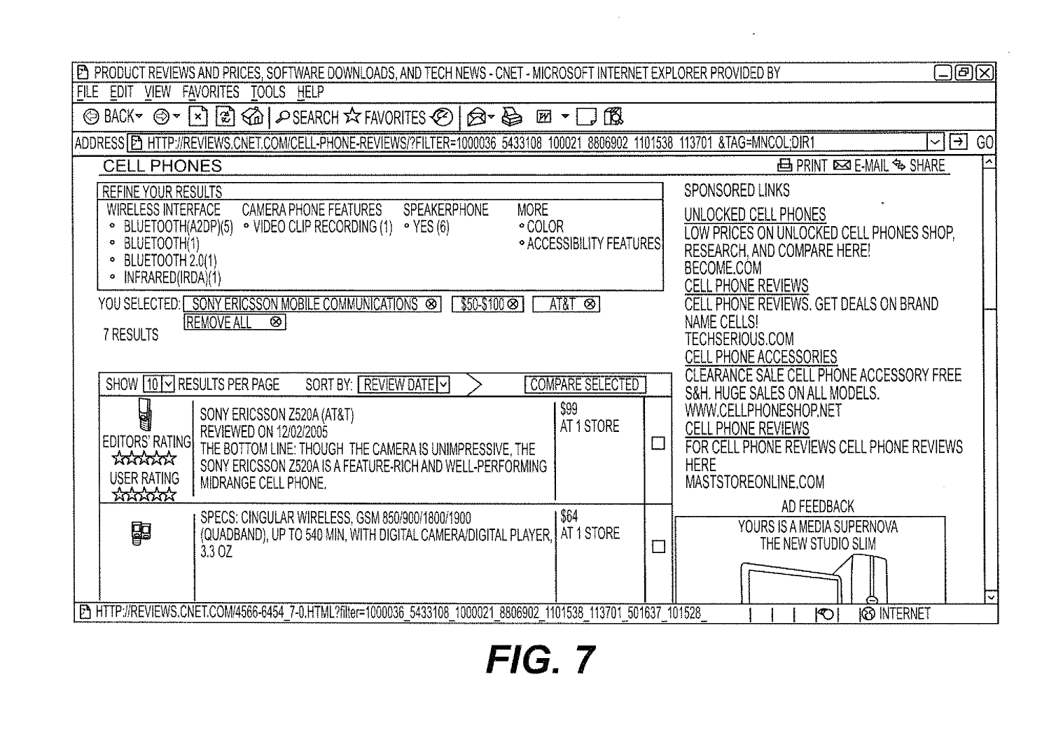

The information shown by the screenshots in FIG. 3-7 is now explained in more detail, as an example of how the user selects filter parameters. FIG. 3 shows a home page of a shopping website, CNET.COM™, which offers access to a catalog of technology products, each of which has multiple attributes associated with it, each of which has a corresponding value. As can be seen in FIG. 3, some of the categories of technology which are in the catalog include “Appliances”, “Cell Phones”, “GPS”, “Laptops”, and many others. When a user clicks on one of these hyperlinks, he or she is brought, for example, to a page as shown in FIG. 4, which would result if the user had chosen the “Cell Phones” category from the homepage in FIG. 3. The catalog then allows the user to navigate from among the many cell phones in the catalog by progressively choosing filter parameters which narrow the selection of cell phones under consideration. Continuing our example, the user might choose that his or her preference was to see cell phones whose service provider was AT&T™. This would restrict consideration by the catalog to the 241 cell phones whose associated service provider is AT&T™. This leads to the resulting display of FIG. 5, which shows the first two phones in an extended list of phones whose service provider is AT&T™. At this point, the set of criteria displays further narrowing filter parameters for selection by the user, such as price, manufacturer, wireless interface, and others. It is to be noted, of course, that this filtration is progressive, i.e. additive. That is, once it has been selected that the service provider is AT&T™, the catalog is designed to reflect, as in FIG. 6, after the appropriate filter parameter selection, only those $50-$100 phones that are also designed to have AT&T™ as a service provider. Proceeding onwards, the user may select the additional filter given these two constraints that the manufacturer of the phone is Sony Ericsson Mobile™ communications, as in FIG. 7. Thus, by adding these progressive filters, the search set narrows from hundreds of potential cell phones to 241 AT&T™ cell phones to 27 AT&T™/$50-$100 cell phones to 7 AT&T™/$50-$100/Sony Ericsson Mobile™ cell phones.

In order to make it easier for users to access products in a catalog of the type that has been described, the embodiments present a way for users to generate and store their own filters for their own subsequent use and for use by members of the community of users that shares use of the embodiments with them.

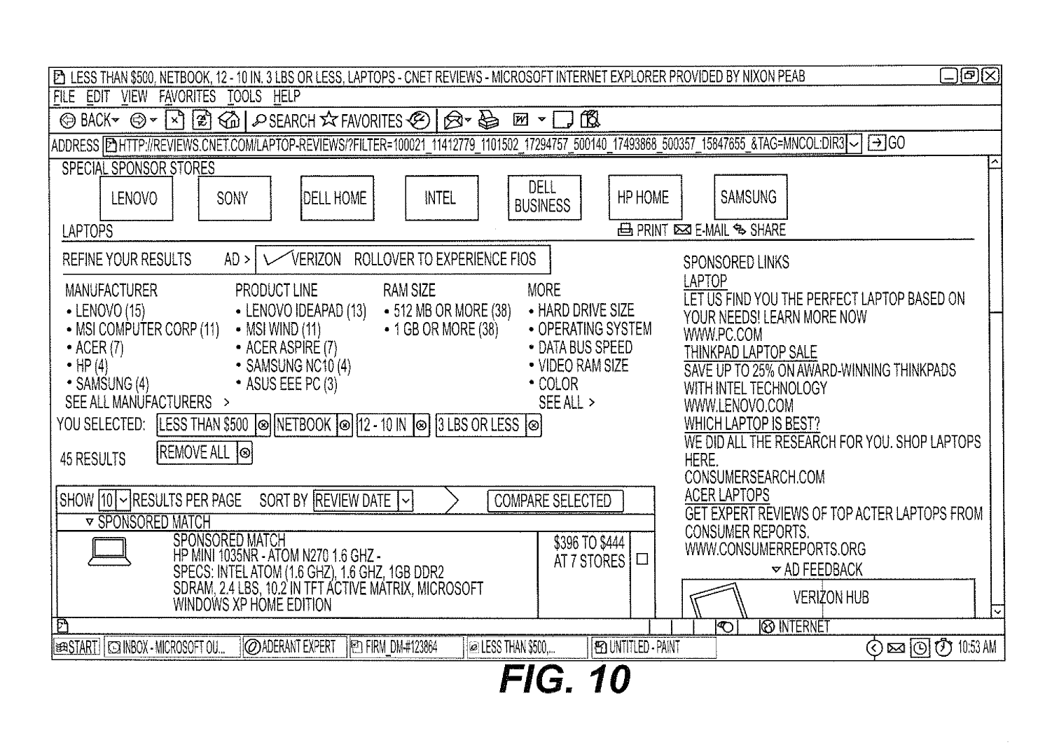

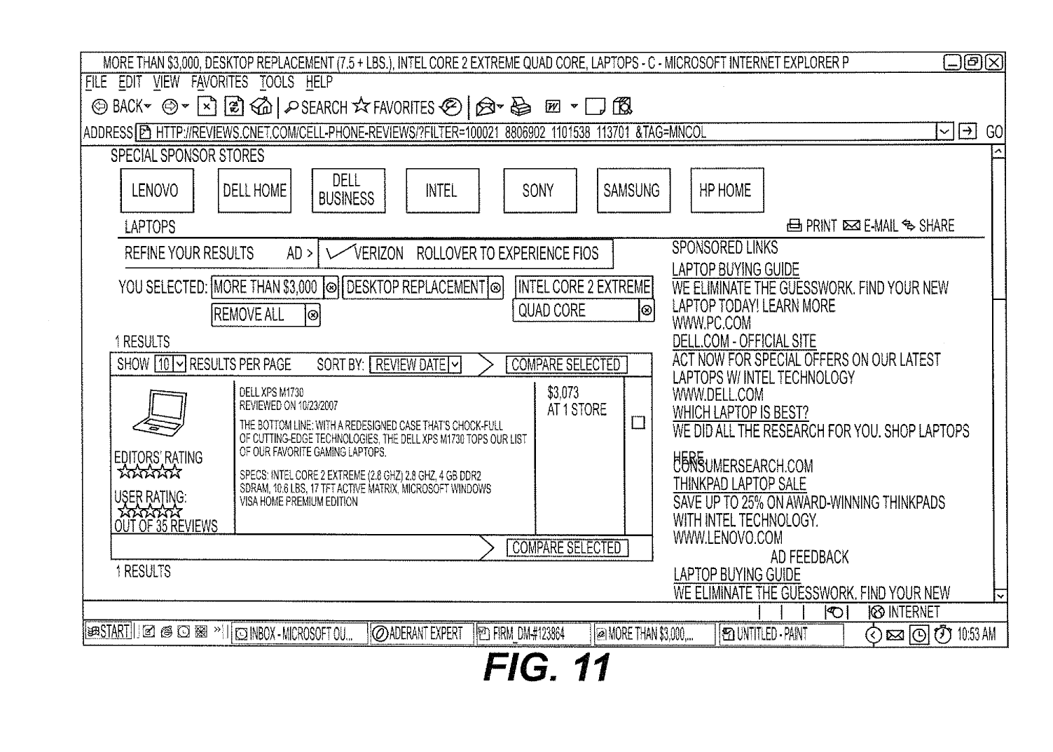

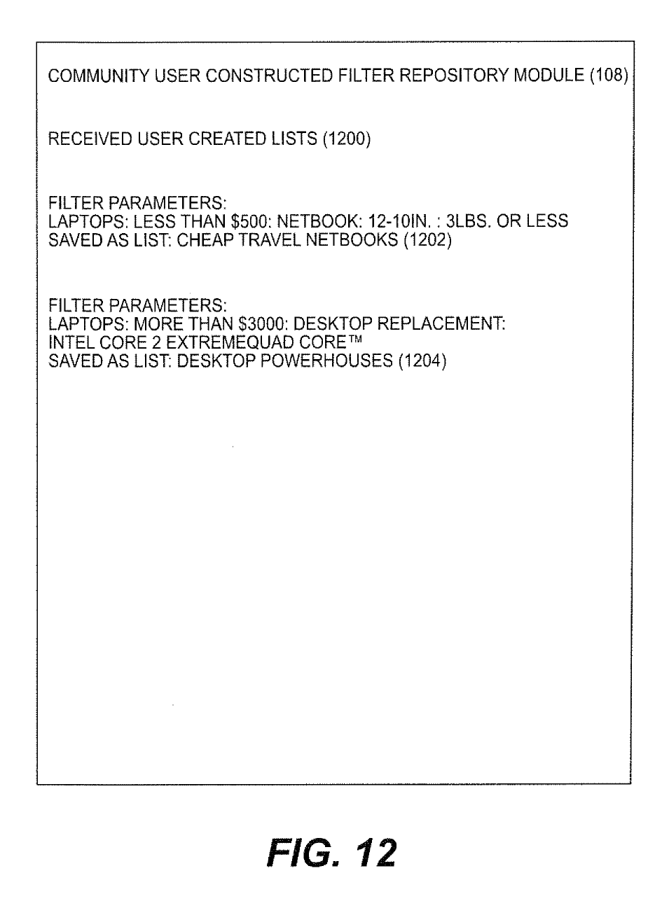

The embodiments involve a record of the filter selections which is portrayed as being stored in one embodiment in FIG. 12 in the community user constructed filter repository module 108. A record of user constructed filters 1200 may consist of a flat file of entries which indicate filters selected by users. Each filter is a sequence of selected filter parameters. The filter parameter selections in the user constructed filters 1200 may be stored in any usable format, but an exemplary format would be to use a text file, and to have one entry per line, with the filter parameters in the filter parameter set separated by commas. Examples are Cheap Travel Notebooks 1202, which encompasses the filter parameters of Laptops, which are less than $500, netbooks, 12-10 in. and 3 lbs. or less, or Desktop Powerhouses 1204, which are more than $3000, desktop replacements, and use an Intel Core 2 Extreme Quad-Core™ processor. One result of executing Cheap Travel Notebooks 1202 is shown as FIG. 10 and one result of executing Desktop Powerhouses 1204 is shown as FIG. 11. However, due to the dynamic nature of the filters, these results pages would be generated every time a user 110 accessed a set of products using a filter This dynamic property gives the approach of selecting a group of products using custom-filters a major advantages over products such as Amazon's List-Mania™, in that the lists associated with filters do not grow “stale”. While the results of executing the user constructed filters in FIG. 10 and FIG. 11 display the relevant results of applying the filters at one point in time, they will be updated the next time the filter is run. Alternatively, embodiments may exist which store the results of applying a filter to the catalog so as to determine what the results of using the user constructed filters was like in the past. By maintaining a record in this embodiment, the user is able to track which products have been recently produced by the user constructed filter.

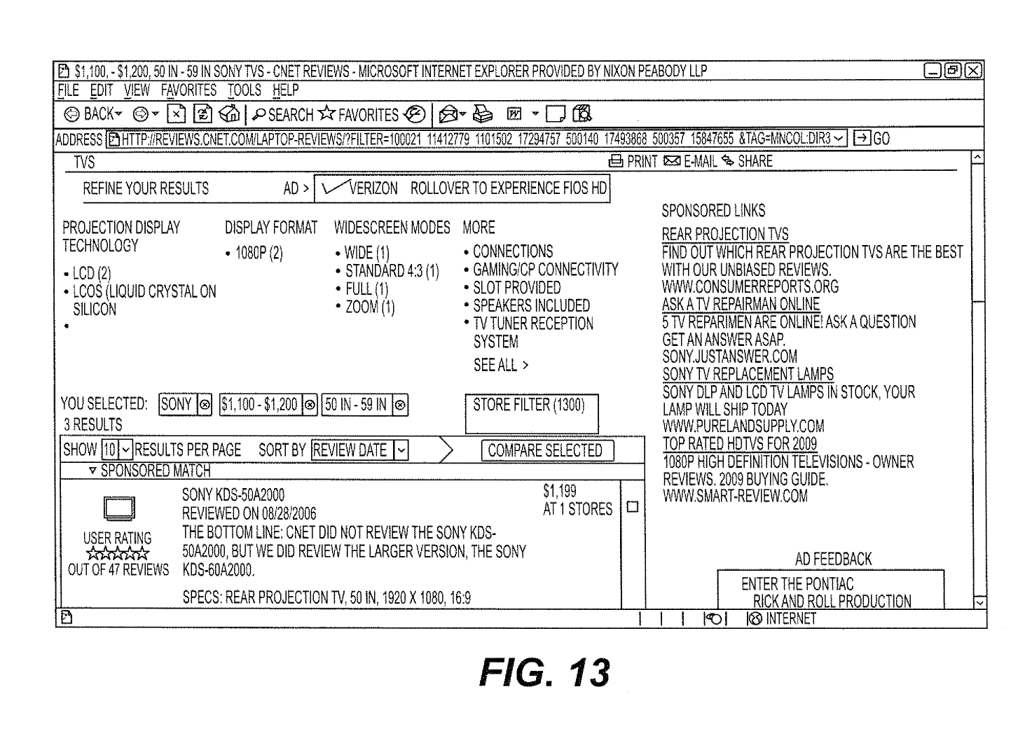

The user constructed filters are constructed by the user in one embodiment in a very simple way, thought of course many interfaces are possible by which the user may select filters, including keyboard input, check boxes, drop down controls, radio button controls, and drag-and-drop selection. Essentially, the user may select filter parameters in a manner analogous to that used in FIG. 3-7, where filter parameters are progressively selected, and except as in FIG. 13, a button 1300 which allows the user to Store Filter 1300. The filter information is then stored as above in the community user constructed filter repository module 108 for later use by other users. The user interface module 106 subsequently moderates the interaction between the users 110 and the community user constructed filter repository module 10. Ideally, the user interface module will allow users 110 to navigate said electronic catalog of products to select products which correspond with the filter parameters in a given user constructed filter. Such navigation may take place via a GUI (Graphical User Interface), which may take the form of a web browser or other graphical Internet navigation tool.

In one embodiment of the invention, there is a method which involves the steps of controlling the operation of functional modules using a computer processor 801, storing an electronic catalog of products with a database module, wherein the catalog comprises a taxonomy of products categories and products within the categories, the catalog further comprising attributes which describe products in a category and at least one value for said attributes 802, defining with a user interface module configured to allow one or more users to define one or more user constructed filters, wherein each user constructed filter includes a set of filter parameters, each of which specifies at least one of a product category and an attribute. which when applied to the catalog generates a subset of products in the catalog which correspond with the filter parameters 803, and storing a community user constructed filter repository module, which stores said user constructed filters and allows subsequent access to the catalog via the user constructed filters by said one or more users by applying the user constructed filter to a subset of products in the catalog which correspond with the filter parameters given the current state of the catalog at the time of the access 804.

Once the users have stored the user constructed filters in the community user constructed filter repository module 108, various embodiments may offer methods of regulating community access to said user constructed filters. Such embodiments may additionally comprise a community user constructed filter repository privilege control module 120, which selectively allows some users to contribute and access user constructed filters, and prevents others form doings so, depending on the users' identities or relationships to other users. For example, in such a system it may be required that a user 110 must log on to said community user constructed filter repository privilege control module before he or she is allowed to contribute filters to the system. An additional feature is that the community user constructed filter repository privilege control module 120 may comprise one or more superuser accounts, which have the sole privilege of editing filters created by other users 110.

The community user constructed filter repository module 108 should have several capabilities. It should be capable of forming the union, intersection, and set difference of two filters. Additionally, it should be capable of storing and managing at least one title for each user constructed filter in the community user constructed filter repository module 108 at the time of creation of the user constructed filter, or alternatively titles may be added to user constructed filters subsequently.

The community user constructed filter repository module 108 should also be capable of ranking the filters in the repository, and displaying them according to popularity, or with the most recently constructed user constructed filter first. It should also have the additional management features for the user constructed filters that the community user constructed filter repository module 108 is configured to allow a user to do one or more of: sending an e-mail, sending a TXT message, or sending an IM message with information about how to access a user created filter to another user of the system. Another feature which some embodiments possess is that the community user constructed filter repository module 108 is configured to automatically do one or more of: sending an e-mail, sending a TXT message, or sending an IM message to alert a user 110 when the subset of products in the catalog that the user created filter corresponds with changes.

Thus, the embodiments allow collection of information about the users' filter preferences which can reflect not only long-term trends in filter selection, but can also be used to determine how the relationship between these trends and the user's present interests indicate ways of effectively marketing to the user. Thus, these embodiments represent a powerful and sophisticated e-commerce tool which brings unexpected advantages to the field of marketing by monitoring the filter data.

It should be noted that the content targeting system 100 is illustrated and discussed herein as having various modules which perform particular functions and interact with one another It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

While various embodiments in accordance with the present invention have been shown and described, it is understood that the invention is not limited thereto. The present invention may be changed, modified and further applied by those skilled in the art Therefore, this invention is not limited to the detail show and described previously, but also includes all such changes and modifications.

What is claimed is:

1. A computer system, for managing community filters to be applied to a product catalog, comprising:
a database module that stores an electronic catalog of products, wherein the catalog comprises a taxonomy of products categories and products within the categories, the catalog further comprising attributes which describe products in a category and at least one value for said attributes;
a user interface module configured to allow one or more users to define one or more user constructed filters, wherein each user constructed filter includes a set of filter parameters, each of which specifies at least one of a product category and an attribute, which when applied to the catalog generates a subset of products in the catalog which correspond with the filter parameters;
and a community user constructed filter repository module, which stores said user constructed filters and allows subsequent access to the catalog via the user constructed filters by said one or more users by applying the user constructed filter to a subset of products in the catalog which correspond with the filter parameters given the current state of the catalog at the time of the access.

2. A system as in claim 1, wherein said user interface module further allows the user to navigate said electronic catalog of products to select products which correspond with the filter parameters in a given user constructed filter.

3. A system as in claim 2, wherein said navigation takes place using a GUI (Graphical User Interface).

4. A system as in claim 3, wherein said user interface module includes a web browser.

5. A system as in claim 1, further comprising a community user constructed filter repository privilege control module, which selectively allows some users to contribute and access user constructed filters and prevents others from doing so, depending on the users' identities or relationships to other users.

6. A system as in claim 5, wherein a user must log on to said community user constructed filter repository privilege control module before he or she is allowed to contribute lists to said system.

7. A system as in claim 6, wherein said community user constructed filter repository privilege control module further comprises one or more superuser accounts, which have the sole privilege of editing lists contributed by other users.

8. A system as in claim 1, wherein said at least attribute variable includes at least one of: brands, prices, and technology.

9. A system as in claim 1, wherein said community user constructed filter repository module can forms the union of two or more users' user constructed filter, and store it as a new user constructed filter.

10. A system as in claim 1, wherein said community user constructed filter repository module can forms the intersection of two or more users' user constructed filter, and store it as a new user constructed filter.

11. A system as in claim 1, wherein said community user constructed filter repository module can forms the set difference of two or more users' user constructed filter, and store it as a new user constructed filter.

12. A system as in claim 1, wherein the user stores a title for each user created filter in the community user constructed filter repository module list the user constructs at the time of construction of the user constructed filter.

13. A system as in claim 1, wherein the user constructed filters are ranked and displayed according to popularity.

14. A system as in claim 1, wherein the user constructed filters are ranked and displayed with the most recently constructed user constructed filters first.

15. A system as in claim 1, wherein said community user constructed filter repository is configured to allow a user to do one or more of: sending an e-mail, sending a TXT message, or sending an IM message with information about how to access a user constructed filter to another user of the system.

16. A system as in claim 1, wherein said community user constructed filter repository is configured to automatically do one or more of: sending an e-mail, sending a TXT message, or sending an IM message with updated information about a user constructed filter to that user or another user of the system when the subset of products in the catalog that the user constructed filter corresponds with changes.

17. A system as in claim 1, where said community user constructed filter repository module further stores the results of applying the user constructed filter to the catalog and allows subsequent retrieval of said results and tracking of which results are recent.

18. The system of claim 1, wherein said products are digital media.

19. The system of claim 18, wherein said digital media products consist of one or more of digital text, audio, MIDI data, recorded audiobooks, digital music, bitmapped and/or vector graphics, digital photographs, video, movies, TV episodes, digital documents, animations, software, web content, multimedia, or encoded or archived data.

20. The system of claim 19, wherein the catalog contains items of digital content and items of merchandise, and some items of digital content are associated with the items of merchandise.

21. A method involving steps to be performed on a computing system consisting of multiple modules designed to perform computing functions which transform data monitoring results, wherein at least part of the computing system's functionality is performed by hardware, comprising:
controlling the operation of functional modules using a computer processor;
storing an electronic catalog of products with a database module, wherein the catalog comprises a taxonomy of products categories and products within the categories, the catalog further comprising attributes which describe products in a category and at least one value for said attributes;
defining with a user interface module configured to allow one or more users to define one or more user constructed filters, wherein each user constructed filter includes a set of filter parameters, each of which specifies at least one of a product category and an attribute, which when applied to the catalog generates a subset of products in the catalog which correspond with the filter parameters;
storing a community user constructed filter repository module, which stores said user constructed filters and allows subsequent access to the catalog via the user constructed filters by said one or more users by applying the user constructed filter to a subset of products in the catalog which correspond with the filter parameters given the current state of the catalog at the time of the access.

22. A method as in claim 21, wherein said user interface module further allows the user to navigate said electronic catalog of products to select products which correspond with the filter parameters in a given user constructed filter.

23. A method as in claim 22, wherein said navigation takes place using a GUI (Graphical User Interface).

24. A method as in claim 23, wherein said user interface module includes a web browser.

25. A method as in claim 21, further comprising the step of regulating access using a community user constructed filter repository privilege control module, which selectively allows some users to contribute and access user constructed filters and prevents others from doing so, depending on the users' identities or relationships to other users.

26. A method as in claim 25, wherein a user must log on to said community user constructed filter repository privilege control module before he or she is allowed to contribute lists to said system.

27. A method as in claim 26, wherein said community user constructed filter repository privilege control module further comprises one or more superuser accounts, which have the sole privilege of editing lists contributed by other users.

28. A method as in claim 21, wherein said at least attribute variable includes at least one of: brands, prices, and technology.

29. A method as in claim 21, wherein said community user constructed filter repository module can forms the union of two or more users' user constructed filter, and store it as a new user constructed filter.

30. A method as in claim 21, wherein said community user constructed filter repository module can forms the intersection of two or more users' user constructed filter, and store it as a new user constructed filter.

31. A method as in claim 21, wherein said community user constructed filter repository module can forms the set difference of two or more users' user constructed filter, and store it as a new user constructed filter.

32. A method as in claim 21, wherein the user stores a title for each user created filter in the community user constructed filter repository module list the user constructs at the time of construction of the user constructed filter.

33. A method as in claim 21, wherein the user constructed filters are ranked and displayed according to popularity.

34. A method as in claim 21, wherein the user constructed filters are ranked and displayed with the most recently constructed user constructed filters first.

35. A method as in claim 21, wherein said community user constructed filter repository is configured to allow a user to do one or more of: sending an e-mail, sending a TXT message, or sending an IM message with information about how to access a user constructed filter to another user of the system.

36. A method as in claim 21, wherein said community user constructed filter repository is configured to automatically o do one or more of: sending an e-mail, sending a TXT message, or sending an IM message with updated information about a user constructed filter to that user or another user of the system when the subset of products in the catalog that the user constructed filter corresponds with changes.

37. A method as in claim 21, where said community user constructed filter repository module further stores the results of applying the user constructed filter to the catalog and allows subsequent retrieval of said results and tracking of which results are recent.

38. The method of claim 21, wherein said products are digital media.

39. The method of claim 38, wherein said digital media products consist of one or more of digital text, audio, MIDI data, recorded audiobooks, digital music, bitmapped and/or vector graphics, digital photographs, video, movies, TV episodes, digital documents, animations, software, web content, multimedia, or encoded or archived data.

40. The method of claim 39, wherein the catalog contains items of digital content and items of merchandise, and some items of digital content are associated with the items of merchandise.

41. An apparatus designed to perform computing functions which transform data monitoring results, wherein at least part of the apparatus's functionality is performed by hardware, comprising:
means for controlling the operation of the functional modules using a computer processor;
means for storing an electronic catalog of products with a database module, wherein the catalog comprises a taxonomy of products categories and products within the categories, the catalog further comprising attributes which describe products in a category and at least one value for said attributes;
means for defining with a user interface module configured to allow one or more users to define one or more user constructed filters, wherein each user constructed filter includes a set of filter parameters, each of which specifies at least one of a product category and an attribute, which when applied to the catalog generates a subset of products in the catalog which correspond with the filter parameters;
and means for storing a community user constructed filter repository module, which stores said user constructed filters and allows subsequent access to the catalog via the user constructed filters by said one or more users by applying the user constructed filter to a subset of products in the catalog which correspond with the filter parameters given the current state of the catalog at the time of the access.

42. An apparatus as in claim 41, wherein said user interface module further allows the user to navigate said electronic catalog of products to select products which correspond with the filter parameters in a given user constructed filter.

43. An apparatus as in claim 42, wherein said navigation takes place using a GUI (Graphical User Interface).

44. An apparatus as in claim 43, wherein said user interface module includes a web browser.

45. An apparatus as in claim 41, further comprising means for regulating access using a community user constructed filter repository privilege control module, which selectively allows some users to contribute and access user constructed filters and prevents others from doing so, depending on the users' identities or relationships to other users.

46. A method as in claim 45, wherein a user must log on to said community user constructed filter repository privilege control module before he or she is allowed to contribute lists to said system.

47. An apparatus as in claim 46, wherein said community user constructed filter repository privilege control module further comprises one or more superuser accounts, which have the sole privilege of editing lists contributed by other users.

48. An apparatus as in claim 41, wherein said at least attribute variable includes at least one of: brands, prices, and technology.

49. An apparatus as in claim 41, wherein said community user constructed filter repository module can forms the union of two or more users' user constructed filter, and store it as a new user constructed filter.

50. An apparatus as in claim 41, wherein said community user constructed filter repository module can forms the intersection of two or more users' user constructed filter, and store it as a new user constructed filter.

51. An apparatus as in claim 41, wherein said community user constructed filter repository module can forms the set difference of two or more users' user constructed filter, and store it as a new user constructed filter.

52. An apparatus as in claim 41, wherein the user stores a title for each user created filter in the community user constructed filter repository module list the user constructs at the time of construction of the user constructed filter.

53. An apparatus as in claim 41, wherein the user constructed filters are ranked and displayed according to popularity.

54. An apparatus as in claim 41, wherein the user constructed filters are ranked and displayed with the most recently constructed user constructed filters first.

55. An apparatus as in claim 41, wherein said community user constructed filter repository is configured to allow a user to do one or more of: sending an e-mail, sending a TXT message, or sending an IM message with information about how to access a user constructed filter to another user of the system.

56. An apparatus as in claim 41, wherein said community user constructed filter repository is configured to automatically o do one or more of: sending an e-mail, sending a TXT message, or sending an IM message with updated information about a user constructed filter to that user or another user of the system when the subset of products in the catalog that the user constructed filter corresponds with changes.

57. An apparatus as in claim 41, where said community user constructed filter repository module further stores the results of applying the user constructed filter to the catalog and allows subsequent retrieval of said results and tracking of which results are recent.

58. The apparatus of claim 41, wherein said products are digital media.

59. The apparatus of claim 58, wherein said digital media products consist of one or more of digital text, audio, MIDI data, recorded audiobooks, digital music, bitmapped and/or vector graphics, digital photographs, video, movies, TV episodes, digital documents, animations, software, web content, multimedia, or encoded or archived data.

60. The apparatus of claim 59, wherein the catalog contains items of digital content and items of merchandise, and some items of digital content are associated with the items of merchandise.

61. Computer readable media, having instructions stored thereon, wherein the instructions, when executed by a processor, perform computing functions which transform data monitoring results, comprising:
instructions for controlling the operation of the functional modules using a computer processor;
instructions for storing an electronic catalog of products with a database module, wherein the catalog comprises a taxonomy of products categories and products within the categories, the catalog further comprising attributes which describe products in a category and at least one value for said attributes;
instructions for defining with a user interface module configured to allow one or more users to define one or more user constructed filters, wherein each user constructed filter includes a set of filter parameters, each of which specifies at least one of a product category and an attribute, which when applied to the catalog generates a subset of products in the catalog which correspond with the filter parameters;
and instructions for storing a community user constructed filter repository module, which stores said user constructed filters and allows subsequent access to the catalog via the user constructed filters by said one or more users by applying the user constructed filter to a subset of products in the catalog which correspond with the filter parameters given the current state of the catalog at the time of the access.

62. Computer readable media as in claim 61, wherein said user interface module further allows the user to navigate said electronic catalog of products to select products which correspond with the filter parameters in a given user constructed filter.

63. Computer readable media as in claim 62, wherein said navigation takes place using a GUI (Graphical User Interface).

64. Computer readable media as in claim 63, wherein said user interface module includes a web browser.

65. Computer readable media as in claim 61, further comprising instructions for regulating access using a community user constructed filter repository privilege control module, which selectively allows some users to contribute and access user constructed filters and prevents others from doing so, depending on the users' identities or relationships to other users.

66. Computer readable media as in claim 65, wherein a user must log on to said community user constructed filter repository privilege control module before he or she is allowed to contribute lists to said system.

67. Computer readable media as in claim 66, wherein said community user constructed filter repository privilege control module further comprises one or more superuser accounts, which have the sole privilege of editing lists contributed by other users.

68. Computer readable media as in claim 61, wherein said at least attribute variable includes at least one of: brands, prices, and technology.

69. Computer readable media as in claim 61, wherein said community user constructed filter repository module can forms the union of two or more users' user constructed filter, and store it as a new user constructed filter.

70. Computer readable media as in claim 61, wherein said community user constructed filter repository module can forms the intersection of two or more users' user constructed filter, and store it as a new user constructed filter.

71. Computer readable media as in claim 61, wherein said community user constructed filter repository module can forms the set difference of two or more users' user constructed filter, and store it as a new user constructed filter.

72. Computer readable media as in claim 61, wherein the user stores a title for each user created filter in the community user constructed filter repository module list the user constructs at the time of construction of the user constructed filter.

73. Computer readable media as in claim 61, wherein the user constructed filters are ranked and displayed according to popularity.

74. Computer readable media as in claim 61, wherein the user constructed filters are ranked and displayed with the most recently constructed user constructed filters first.

75. Computer readable media as in claim 61, wherein said community user constructed filter repository is configured to allow a user to do one or more of: sending an e-mail, sending a TXT message, or sending an IM message with information about how to access a user constructed filter to another user of the system.

76. Computer readable media as in claim 61, wherein said community user constructed filter repository is configured to automatically o do one or more of: sending an e-mail, sending a TXT message, or sending an IM message with updated information about a user constructed filter to that user or another user of the system when the subset of products in the catalog that the user constructed filter corresponds with changes.

77. Computer readable media as in claim 61, where said community user constructed filter repository module further stores the results of applying the user constructed filter to the catalog and allows subsequent retrieval of said results and tracking of which results are recent.

78. The computer readable media of claim 61, wherein said products are digital media.

79. The computer readable media of claim 78, wherein said digital media products consist of one or more of digital text, audio, MIDI data, recorded audiobooks, digital music, bitmapped and/or vector graphics, digital photographs, video, movies, TV episodes, digital documents, animations, software, web content, multimedia, or encoded or archived data.

80. The computer readable media of claim 79, wherein the catalog contains items of digital content and items of merchandise, and some items of digital content are associated with the items of merchandise.
